(19) United States
(12) Patent Application Publication
(10) Pub. No.: US 2019/0052471 A1
(43) Pub. Date: Feb. 14, 2019

(54) PERSONALIZED TOXICITY SHIELD FOR MULTIUSER VIRTUAL ENVIRONMENTS

(71) Applicant: Microsoft Technology Licensing, LLC, Redmond, WA (US)

(72) Inventors: Jennifer PANATTONI, Redmond, WA (US); Colin Stafford WILLY, Bellevue, WA (US); Andreas Keith HOLBROOK, Redmond, WA (US); Roberta McALPINE, Lynnwood, NC (US); Paul David SNYDER, Woodinville, WA (US); Kailas Baban BOBADE, Redmond, WA (US); Jason Gene COON, Duvall, WA (US)

(21) Appl. No.: 15/673,982

(22) Filed: Aug. 10, 2017

(51) Int. Cl. H04L 12/18; H04L 29/08; G06F 3/0484

(52) U.S. Cl. CPC H04L 12/1813; H04L 67/306; A63F 2300/8082; A63F 2300/408; G06F 3/0484

(57) ABSTRACT

Toxicity-shield modules are activated with respect to participants of a multiuser virtual environment to shield individual participants from toxic behaviors. The toxicity-shield modules may be customized for each participant of the multiuser virtual environment based on tolerances of each participant for exposure to predetermined toxic behavior(s). The toxicity-shield modules may be activated during the multiuser virtual environment to monitor communications data (e.g., voice-based and/or text-based “chats” and/or a video stream) between the participants and to manage the exposure level of individual participants to the predetermined toxic behavior(s). For example, under circumstances where a first participant is highly intolerant to usage of a particular expletive whereas a third participant is indifferent to usage of the particular expletive, the toxicity-shield module(s) may identify instances of the particular expletive to prevent the first participant from being exposed to such instances without similarly preventing the third participant from being exposed to such instances.

### BACKGROUND

A multiuser virtual environment provides individuals with the ability to jointly participate in various virtual activities. For example, a multiuser virtual environment may be a multiuser virtual reality environment that provides participants with the ability to remotely interact with other participants either individually or in a team setting. Existing systems and services provide functionality for a group of players participating in a multiuser virtual environment to audibly communicate with one another using an in-session voice “chat” service and/or an in-session text “chat” service.

It is with respect to these considerations and others that the disclosure made herein is presented.

### SUMMARY

This disclosure describes systems and techniques that allow participants in a multiuser virtual environment that are intolerant of predetermined toxic behaviors (e.g., expletives and/or verbally abusive language) to shield themselves from such predetermined toxic behaviors while still conversing with other participants of the multiuser virtual environment. A multiuser virtual environment can be provided and/or hosted by resources (e.g., program code executable to generate game content, program code executable to receive and/or store and/or transmit social media content, devices on a server, networking functionality, etc.) that are developed and/or operated by a virtual environment service provider. In some examples, the virtual environment service provider may be a virtual gaming service that facilitates a multiplayer gaming session that can be executed on computing devices to enable participants to engage with game content provided by the virtual gaming service. In various examples described herein, program code provided by the virtual environment service provider is executable to facilitate a multiuser virtual environment (e.g., by generating the game content) and also to provide communications functionality (e.g., via an application programming interface (API) that provides access to an in-session voice “chat” service) so that the participants in the multiuser virtual environment can exchange voice and/or text communications with one another. Accordingly, in some implementations, the techniques described herein can be implemented in part or in full in association with an in-session voice-based and/or text-based “chat” component. Furthermore, the techniques described herein can be implemented in association with a virtual reality (VR) and/or an augmented reality (AR) session. Furthermore, the techniques described herein can be implemented in association with an online web conferencing system.

In some examples described herein, a first participant of a multiuser virtual environment that wants to communicate with other participants but who is intolerant of a predetermined toxic behavior provides a system with toxicity-tolerance data indicating a tolerance for exposure to the predetermined toxic behavior. Exemplary predetermined toxic behaviors include, but are not limited to, using expletive language in general (e.g., expletive language that is not directed at or intended to harm any particular participant), using verbally abusive language (e.g., directing insults and/or expletive language at one or more particular participants), speaking with a particular tone and/or inflection (e.g., an unpleasant high-pitched plaintive tone), producing one or more inadvertent but undesirable sounds (e.g., breathing heavily onto a microphone), “standing” too close to another participant in a virtual reality environment (e.g., a user may define a three foot virtual wall of personal space), and/or any other suitable behavior that can be readily identified by one or more computing devices and that may negatively impact user experience within the multiuser virtual environment. In various examples, the system may monitor communications data associated with the multiuser virtual environment to identify instances of the predetermined toxic behavior. For example, in a scenario where the toxicity-tolerance data indicates that the participant is intolerant of being exposed to a particular expletive, a system may monitor a conversation(s) between participants of the multiuser virtual environment to identify an instance of the particular expletive being used by a second participant (e.g., in this context an “offending” participant) in the “virtual” presence of the first participant (e.g., in this context an “intolerant” participant).

Based on the toxicity-tolerance data, the system may determine that the first participant is intolerant of the instance of the second participant using the particular expletive. In some implementations, the toxicity-tolerance data may indicate that the first participant is absolutely intolerant of any usage of the particular expletive. For example, the first participant may wish to never be exposed to any other participant using the particular expletive. Additionally or alternatively, the toxicity-tolerance data may indicate that the first participant is intolerant of the particular expletive being used in excess of a usage threshold. For example, the first participant may tolerate infrequent usage of the particular expletive but may be intolerant of constant usage (i.e., usage that exceeds a usage threshold such as, for example, three times within a particular time-span and/or within a particular multiplayer gaming session). Under these circumstances, the system may determine that the first participant is intolerant of the instance of the particular expletive based on the second participant already having used the particular expletive within the multiuser virtual environment a predetermined number of times and/or at a predetermined rate (e.g., more than a predetermined number of times per minute, hour, etc.).

In some implementations, the system may respond to determining that the first participant is intolerant of the instance of the predetermined toxic behavior by preventing the first participant from being exposed to the instance of the predetermined toxic behavior. For example, the system may respond proactively in substantially real-time to prevent a client device of the first participant from exposing (e.g., audibly playing) the instance of the predetermined toxic behavior. As a more specific but nonlimiting example, the system may deploy a participant-selective mute function to toggle an individual stream of the communications data, from the second participant's client device, between an audible-state and a muted-state in substantially real-time so that the first participant remains unaware of the instance of the predetermined toxic behavior was even spoken by the second participant.

In some implementations, the system may respond to determining that the first participant is intolerant of the instance of the predetermined toxic behavior by preventing the first participant from being exposed to a portion of the communications data that corresponds to future toxic behavior by the second participant. For example, the system may respond reactively by “muting” the second participant with respect to the first participant for a predetermined amount of time or until the first participant elects to “unmute” the second participant. Additionally or alternatively, the system may respond by suspending communications privileges of the second participant for a predetermined amount of time. Stated alternatively, the system may temporarily disable communications functionality for a user account that belongs to (or is used by) an offending participant.

The techniques described herein may include generating toxicity-shield modules for managing exposure levels of participants of a multiuser virtual environment to predetermined toxic behaviors. The toxicity-shield modules may be transmitted to client devices associated with individual participants of the multiuser virtual environment to cause the client devices to implement various functionality as described herein. As a specific but nonlimiting example, the techniques described herein may include transmitting a toxicity-shield module to individual client devices for each participant of a multiuser virtual environment. The toxicity-shield modules may be at least partially customized with respect to each participant of the multiuser virtual environment based on corresponding toxicity-tolerance data that indicates tolerances of each participant for exposure to predetermined toxic behavior(s). The toxicity-shield modules may be activated during the multiuser virtual environment to monitor communications data (e.g., voice-based and/or text-based “chats” and/or VR/AR session data, and/or streaming video data) between the participants and, ultimately, to manage the exposure level of individual participants to the predetermined toxic behavior(s). For example, under circumstances where toxicity-tolerance data indicates that a first participant is highly intolerant to usage of a particular expletive whereas a third participant is indifferent to (e.g., is not bothered or offended by) usage of the particular expletive, the toxicity-shield module(s) may identify instances of the particular expletive to prevent the first participant from being exposed to such instances without similarly preventing the third participant from being exposed to such instances. For example, the third participant's client device may expose (e.g., audibly replay via an output device such as a headset) the identified instances of the particular expletive while the first participant's client device is prevented from exposing the very same identified instances of the particular expletive.

In some implementations, a toxicity-shield module may be deployed on a client device of an offending participant to shield other participants from socially toxic behavior that originates with the offending participant. For example, the toxicity-shield module may monitor communications data received via an input device (e.g., a microphone) to identify instances of the predetermined toxic behavior and, ultimately, to prevent those instances from being transmitted to client devices corresponding to other participants that are intolerant of the predetermined toxic behavior (i.e., intolerant participants). Additionally or alternatively, a toxicity-shield module may be deployed on a client device corresponding to an intolerant participant to shield the intolerant participant from socially toxic behavior that originates from an offending participant on a different client device from which chat communications are received. For example, the toxicity-shield module may monitor communications data in real-time (e.g., as it is received via a network) to identify instances of the predetermined toxic behavior and, ultimately, to prevent those instances from being exposed by an output device (e.g., being rendered on a display and/or audibly-played via one or more speakers).

Therefore, among many other benefits, the techniques herein improve efficiencies with respect to a wide range of computing resources. For instance, human interaction with a multiuser virtual environment may be improved because the use of the techniques disclosed herein enables individual participants of the same multiuser virtual environment to be provided with a unique user experience that is specifically tailored (e.g., personalized) based on how tolerant each participant is to various socially toxic behaviors. More specifically, when a participant is intolerant of a predetermined toxic behavior, instances of the predetermined toxic behavior may be identified and “scrubbed” (e.g., removed) from that participant's unique user experience within the multiuser virtual environment. Other participants that are indifferent to the predetermined toxic behavior may be provided with different unique user experiences in which the instances of the predetermined toxic behavior are not “scrubbed.”

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-executable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram illustrating an example environment in which one or more client devices, that are being used to participate in a multiuser virtual environment, can activate a feature that enables a participant to communicate with other participants while being shielded from predetermined toxic behaviors that are exhibited by the other participants.

FIG. 2 is a schematic diagram of an illustrative computing environment that is configured to deploy a machine learning engine to analyze communications data to generate a toxicity prediction model.

FIG. 3A illustrates an exemplary dataflow scenario in which a toxicity shield module (TSM) is operated on a client device of an offending participant to prevent transmission of an instance of a predetermined toxic behavior to another client device of a participant that is intolerant of the predetermined toxic behavior.

FIG. 3B illustrates an exemplary dataflow scenario in which a TSM is operated on a client device of a participant that is intolerant of a predetermined toxic behavior to prevent a received instance of the predetermined toxic behavior from being exposed via an input/output device.

FIG. 4 is a flow diagram of an example method for selectively shielding a participant of a multiuser virtual environment from a predetermined toxic behavior that the participant is intolerant of while exposing the predetermined toxic behavior to other participants of the multiuser virtual environment.

FIG. 5 is a flow diagram of an example method for selectively suspending communications functionality of a participant's user account in response to that participant exhibiting a predetermined toxic behavior within a multiuser virtual environment.

FIG. 6 is a diagram illustrating components of an example device configured to generate and/or deploy a toxicity shield module according to the techniques disclosed herein.

### DETAILED DESCRIPTION

Examples described herein provide various techniques that enable participants in a multiuser virtual environment that are intolerant of predetermined toxic behaviors (e.g., usage of expletives and/or verbally abusive language) to shield themselves from such predetermined toxic behaviors while still conversing with other participants of the multiuser virtual environment. The examples allow an individual participant to provide toxicity-tolerance data that indicates one or more predetermined toxic behaviors that he or she does not wish to be exposed to within the multiuser virtual environment. Based on the toxicity-tolerance data, a system may monitor voice-based and/or text-based “chat” sessions between participants of the multiuser virtual environment to identify and ultimately shield the individual participant from instances of the predetermined toxic behavior. As a more specific but nonlimiting example, the individual participant may indicate an intolerance towards a particular expletive (e.g., a profane and/or vulgar word) to prevent the participant from being exposed to the particular expletive while participating in the multiuser virtual environment.

In some implementations, the system may proactively prevent individual participants from being exposed to the predetermined toxic behavior in real-time. For example, the system may immediately identify a particular instance of the particular expletive as it is spoken by an offending participant and prevent that particular instance from being exposed to at least some other participants of the multiuser virtual environment. In some applications, the system may reactively prevent the individual participant from being exposed to future instances of the predetermined toxic behavior from the offending participant in response to the particular instance being spoken by the offending participant. For example, the system may identify the particular instance of the predetermined toxic behavior shortly after it is spoken by the offending participant and prevent the offending participant from transmitting future communications to at least some other participants of the multiuser virtual environment. Stated alternatively, the offending participant may have their communications privileges disabled for a predetermined period of time (e.g., for the current session, for one hour, for one week, for one year, etc.) in response to exhibiting the predetermined toxic behavior.

As described in more detail below, the disclosed techniques provide benefits over conventional communications techniques for at least the reason that human interaction with computing devices and/or multiuser virtual environments is improved by providing individual participants with a unique user experience that is specifically tailored to how tolerant each participant is of various behaviors (e.g., swearing, whining, etc.). More specifically, in many cases multiuser virtual environments are largely anonymous with individual participants being identifiable only by a screen name—if at all. The anonymity of these multiuser virtual environments has the unfortunate side effect of online disinhibition due, in part, to a lack of repercussions of socially toxic behavior. In particular, some participants find it all too easy to relentlessly use profane language or even hurl insults at other participants of a multiuser virtual environments with little regard for the potential harm that this behavior may cause. In some cases, a participant may not even be aware that their behavior is viewed as “toxic” by others within a multiuser virtual environment. For example, a player using the in-session voice “chat” service during a multiplayer gaming session may use constant profanity without malicious intent but while being ignorant of the fact that such profanity is highly offensive to another player within that multiplayer gaming session. Without the ability to shield oneself from the toxicity that builds in multiuser virtual environments, many participants' user experience is greatly diminished due to feeling relentlessly belittled, verbally attacked, or even merely exposed against their will to toxic behavior. In contrast to conventional communications techniques which leaves individual participants of a multiuser virtual environment at the mercy of other participants' desire to spew toxic behavior, the techniques disclosed herein provide individual participants with a powerful defense mechanism against such other participants' toxicity. For example, if an individual participant does not wish to be exposed to vulgar imagery and/or profane language, this individual participant can deploy the techniques described herein to shield him or herself from such toxic behavior regardless of how vehemently other participants within the same multiuser virtual environments desire to spew such toxic behavior.

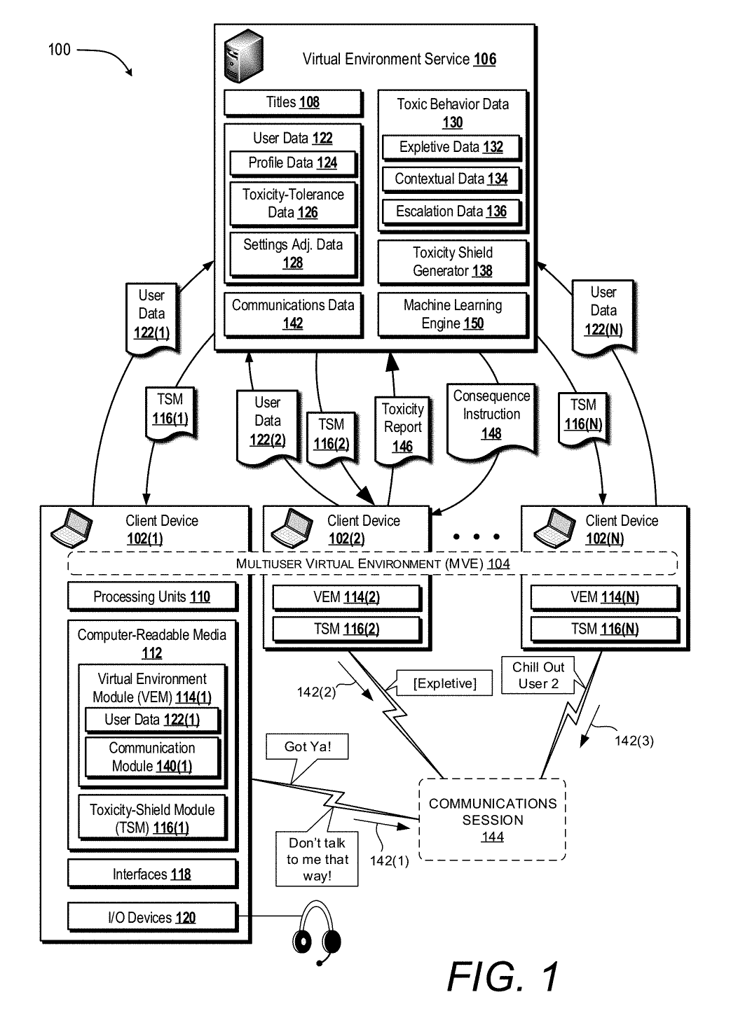

Furthermore, the disclosed techniques reduce bandwidth usage over conventional communications techniques because portions of communications data (e.g., an audio data stream) that would likely be offensive (or otherwise bothersome) to individual participants are identified and prevented from being transmitted to client devices associated with those individual participants. In particular, by identifying and preventing transmission of selected “offensive” portions of the communications data, the disclosed techniques reduce bandwidth usage as compared to conventional communications techniques. Various examples, scenarios, and aspects that effectively shield participants of a multiuser virtual environment from predetermined toxic behaviors are described below with references to FIGS. 1-6.

FIG. 1 is a diagram illustrating an example environment 100 in which one or more client computing devices 102 (referred to herein as “client devices”), that are being used participate in a multiuser virtual environment 104, can activate a feature that enables a particular participant (e.g., may be referred to herein as “user” and/or “player” depending on context) to communicate with other participants while being shielded from one or more predetermined toxic behaviors being exhibited by one or more of the other participants. For illustrative purposes, aspects of the presently disclosed techniques are mostly described in the context of the multiuser virtual environment 104 being a multiplayer gaming session that includes an in-session voice “chat” functionality enabling participants to use their respective client device 102 to transmit and/or receive substantially real-time voice-based communications with other participants of the multiplayer gaming session. It will become apparent that various aspects described herein can be implemented in alternate contexts such as, for example, in the context of a social media platform.

The client devices 102(1) . . . 102(N) enable their respective users to participate, individually or as a team, in the multiuser virtual environment 104. The multiuser virtual environment 104 can be hosted, over a network, by a virtual environment service 106 (e.g., PLAYSTATION NOW, NINTENDO NETWORK, XBOX LIVE, FACEBOOK, SKYPE FOR BUSINESS, SKYPE, etc.). In some examples, the virtual environment service 106 can provide game content based on various title(s) 108 so that users of the client devices 102(1) . . . 102(N) can participate in the multiuser virtual environment 104. A title 108 can comprise resources (e.g., program code, devices, networking functionality, etc.) useable to execute the multiuser virtual environment 104 across the client devices 102(1) . . . 102(N). In the context of the multiuser virtual environment 104 being a multiplayer gaming session, a title 108 can be associated with an action game, a fighting game, a war game, a role-playing game, a strategy game, a racing game, a sports game, or the like. In some implementations, the virtual environment service 106 may at least partially host the multiuser virtual environment 104. Additionally or alternatively, the multiuser virtual environment 104 can be hosted by one or more of the client devices 102(1) . . . 102(N) without the virtual environment service 106 (e.g., via peer-to-peer network communications).

A client device (e.g., one of client device(s) 102(1) . . . 102(N)) can belong to a variety of classes of devices such as gaming console-type devices (SONY PLAYSTATION, MICROSOFT XBOX, etc.), desktop computer-type devices, mobile-type devices, special purpose-type devices, embedded-type devices, and/or wearable-type devices, and/or any other suitable computing device whether currently existing or subsequently developed. Thus, a client device can include, but is not limited to, a game console, a desktop computer, a gaming device, a tablet computer, a personal data assistant (PDA), a mobile phone/tablet hybrid, a laptop computer, a telecommunication device, a wearable device, a virtual reality (VR) device, an augmented reality (AR) device, an implanted computing device, a network-enabled television, an integrated component (e.g., a peripheral device) for inclusion in a computing device, or any other sort of computing device. In some implementations, a client device includes input/output (I/O) interfaces that enable communications with input/output devices such as user input devices including peripheral input devices (e.g., a game controller, a keyboard, a mouse, a pen, a voice input device, a touch input device, a gestural input device, and the like) and/or output devices including peripheral output devices (e.g., a display, a printer, audio speakers, a haptic output device, and the like).

Client device(s) 102(1) . . . 102(N) of the various classes and device types can represent any type of computing device having one or more processing unit(s) 110 operably connected to computer-readable media 112 such as via a bus (not shown), which in some instances can include one or more of a system bus, a data bus, an address bus, a PCI bus, a Mini-PCI bus, and any variety of local, peripheral, and/or independent buses.

Executable instructions stored on computer-readable media 112 can include an operating system that can deploy, for example, a virtual environment module (VEM) 114, a toxicity-shield module (TSM) 116, and other modules, programs, or applications that are loadable and executable by the processing unit(s) 110. Client computing device(s) 102(1) . . . 102(N) can also include one or more interface(s) 118 to enable communications between client computing device(s) 102(1) . . . 102(N) and other networked devices and/or systems associated with the virtual environment service 106. Such interface(s) 118 can include one or more network interface controllers (NICs) or other types of transceiver devices to send and receive communications data over one or more networks. Client computing device(s) 102(1) . . . 102(N) can also include one or more input and/or output devices 120 to enable individual participants to use the in-session voice “chat” functionality to transmit and/or receive substantially real-time voice-based communications with other participants of the multiuser virtual environment 106. In the illustrated scenario, the input and/or output devices 120 is illustrated as including a headset comprised of speakers to enable a participant to hear communications from other participants and a microphone to enable the participant to speak and ultimately send communications to the other participants.

In the example environment 100 of FIG. 1, client devices 102(1) . . . 102(N) can use their respective VEM 114 to connect with one another and/or the virtual environment service 106 in order to participate in the multiuser virtual environment 104. For instance, in the context of the present example where the multiuser virtual environment 104 is a multiplayer gaming session, a participant can utilize a client computing device 102(1) to connect with the virtual environment service 106 and, ultimately, to access resources of a title 108. For example, individual participants may utilize a corresponding VEM 114 to provide user data 122 to the virtual environment service 106. In the illustrated scenario, a first participant that is operating the client device 102(1) utilizes his or her VEM 114(1) to provide user data 122(1) to the virtual environment service 106, a second participant that is operating the client device 102(2) utilizes his or her VEM 114(2) to provide user data 122(2) to the virtual environment service 106, and so on. In some implementations, the user data 122 may be received via a parental control portal from which one or more account administrators (e.g., a parent of a child) is able to set toxicity tolerances associated with an account of an individual participant the first participant (e.g., the child).

In various implementations, the user data 122 may include profile data 124 that defines unique participant profiles. The virtual environment service 106 may utilize the profile data 124 that is received from the individual participants to generate the unique participant profiles corresponding to each individual participant. A participant profile can include one or more of an identity of a participant (e.g., a unique identifier such as a user name, an actual name, etc.), a skill level of the participant, a rating for the participant, an age of the participant, a friends and/or family list for the participant, a location of the participant, etc. Participant profiles can be used to register participants for multiuser virtual environments such as, for example an individual multiplayer gaming session.

In various implementations, the multiuser virtual environment 104 is at least partially anonymous such that at least some portions of a participant profile (e.g., a participant's real name) may be shielded from other participants within the multiuser virtual environment 104. For example, individual participants within a multiplayer gaming session may be identifiable by a screen name only or may be wholly unidentifiable to other participants of the multiplayer gaming session. As described above, it can be appreciated that the relative anonymity of the multiuser virtual environment 104 may produce the unfortunate side effect of online disinhibition due to the reduction in social repercussions (e.g., poor reputation, isolation from social circles, being left uninvited to future multiuser virtual environments, etc.) of socially toxic behavior. In particular, a lack of restraint that individual participants feel when communicating online, as compared to when communicating in-person, may result in online disinhibition. Although anonymity is a main factor to online disinhibition other factors include, but are not limited to, empathy deficit that is caused by a lack of nonverbal feedback (e.g., facial expressions and/or other body language that may communicate an intolerance toward socially toxic behavior). Accordingly, it can be appreciated that the techniques described herein are not limited to anonymous and/or partially anonymous multiuser virtual environments but rather can be implemented within even wholly non-anonymous multiuser virtual environments such as, for example, “social network” multiuser virtual environments.

In various implementations, the user data 122 may include toxicity-tolerance data 126 that indicates tolerances of individual participants to being exposed to one or more predetermined toxic behaviors that are defined within toxic behavior data 130. As described above, the toxic behavior data 130 may indicate any type of behavior that can be exhibited within the multiuser virtual environment 104 and that may potentially be viewed as socially toxic by one or more participants of the multiuser virtual environment.

In some implementations, the virtual environment module 114 may include one or more user interface elements that enable a participant to control a degree to which various types of communications are monitored by his or her corresponding toxicity shield module 116. For example, the user interface elements may enable the participant to select a degree (e.g., along a sliding scale) to which one or more types of communications and/or types of content are monitored. Exemplary types of communications include, but are not limited to, voice messages, text messages, in-session “chat” communications, and/or communications having a particular voice-inflection. Exemplary types of content include, but are not limited to, imagery, video content (e.g., violent and/or gory and/or sexually explicit video game content), and/or user-to-user streaming video content.

In some implementations, the virtual environment service 106 may be configured to replicate social awareness in order to manage a toxicity level based on a variety of social factors. Exemplary social factors include but are not limited to age, dialect, region, voice inflection, gamer skill level, and/or facial recognition (e.g., the virtual environment service and/or toxicity shield module 116 may identify predetermined facial characteristics and either shield other users from them and/or monitor a particular participant more closely when their facial expressions indicate they are becoming angry).

In some implementations, the virtual environment service 106 may be programmed to specifically tailor toxicity shield modules 116 according to non-user based factors such as a country (and/or laws thereof) in which a participant resides when participating in a multiuser virtual environment. For example, various countries empower specific agencies to regulate various forms of communications including, but not limited to, online communications. Accordingly, the virtual environment service 106 to be programmed to specifically tailor toxicity shield modules 116 according to one or more governmental regulations and/or laws. At the same time, the virtual environment service 106 may be programmed specifically tailor other toxicity shield modules 116 according to laws and regulations of another country and/or region. Then, when two participants with similar and/or identical toxicity tolerance profiles join the same multiuser virtual environment from countries having different laws, the virtual environment service 106 may be aware of these different laws and specifically tailor each participant's user experience so as to abide by these different laws.

In some implementations, the toxic behavior data 130 may include expletive data 132 that indicates one or more predefined expletives (e.g., exclamatory words that are viewed in a relevant social setting as obscene and/or profane). For example, the expletive data 132 may indicate one or more “swear” words, sexually-explicit words, and/or any other type of word that is generally considered to be impolite, rude, or socially offensive. Thus, according to the techniques described herein, a participant may deploy their respective VEM 114 to browse through the expletive data 132 to select a predefined expletive (and/or to define for oneself for that matter) that he or she does not wish to be exposed to while participating in the multiuser virtual environment 104.

In some implementations, the toxic behavior data 130 may include contextual data 134 that indicates one or more predefined contextual situations that may generally increase and/or decrease a likelihood that any particular instance of behavior is perceived by one or more participants as being socially toxic. As a more specific but nonlimiting example, the contextual data 134 may indicate one or more word-string patterns that indicate an increased likelihood that a particular participant may feel offended by another participant's behavior. To illustrate this point, consider the contextual difference between a first word-string pattern in which a participant uses an expletive as follows “Hey User A, how did you do that? That was [expletive] awesome!” Now, compare the foregoing to a second word-string pattern in which the participant uses the same expletive as follows “Hey User A, you are by far the worst [expletive] player ever! You should just give up, ha-ha-ha.” It can be appreciated that the first word-string pattern corresponds to a use of an expletive in the context of complementing User A whereas the second-word string pattern corresponds to the use of the same expletive in the context of insulting (e.g., “trash-talking” to) User A. Thus, according to the techniques described herein, a participant may deploy their respective VEM 114 to browse through the contextual data 134 to select a predefined contextual situation that he or she does not wish to be exposed to while participating in the multiuser virtual environment 104. For example, a participant may use their respective VEM 114 to indicate that he or she does not mind swearing in general but takes a serious offense to being sworn at by others in an insulting and/or otherwise demeaning manner.

In some implementations, the toxic behavior data 130 may include escalation data 136 that defines indicators of one or more escalatory situations that may lead to an increased likelihood that a participant will begin to exhibit socially toxic behavior. As a more specific but nonlimiting example, the escalation data 136 may indicate various factors that may disinhibit a typical participant such as, for example, being within a “losing-streak” that may frustrate a typical participant, being “ganged-up” on by one or more other users that may make a typical participant feel singled out, and/or any other factor that may be identified by a computing system and that may generally affect a typical participant's behavior toward others. As another example, the escalation data 136 may indicate various audible cues that a typical participant may exhibit when he or she has become and/or is becoming disinhibited with respect to other participants. For example, the escalation data 136 may indicate a tone and/or inflection that a typical participant may exhibit when they are becoming frustrated and/or angry. Thus, according to the techniques described, a system may access escalation data 136 when analyzing communications between participants to identify one or more escalatory situations as they are occurring in real-time (e.g., within a voice-based and/or text-based “chat” session that corresponds to the multiuser virtual environment 104). Once identified, the system may take various mitigated actions such as, for example, pausing communications functionality of one or more participants (e.g., to provide a “cool-down” period), transmitting a warning message to one or more participants indicating a consequence of toxic behavior, etc.

According to the techniques described herein, the toxicity-tolerance data 126 for any particular participant may be based on user-input received from the particular participant (e.g., a participant may explicitly indicate tolerance and/or intolerance toward specific behavior). Additionally or alternatively, the toxicity-tolerance data 126 for any particular participant may be based on generalized tolerance-traits that correspond to people in general (e.g., the system 100 may recognize that an average participant does not tolerate being sworn at). In some embodiments, a user may select between a plurality of default profiles each having varying degrees of tolerance for various predetermined toxic behaviors. For example, a user that does not wish to hear any curse words may select a first default profile whereas another participant that does not mind curse words but does not wish to listen to individual “whine” within a gaming session may select a second default profile. In some implementations, the default profiles may serve as a starting point from which the user may continue to manually alter settings and/or the machine learning engine may continue to learn from the user's reactions to various toxic behaviors.

Based on the toxicity-tolerance data 126, the system 100 may deploy a toxicity shield generator 138 to generate one or more TSMs 116 that may be activated during a communication session 144 that corresponds to the multiuser virtual environment 104. For example, while participating in the multiuser virtual environment 104, individual participants may utilize a communication module 140 to converse with other participants of the multiuser virtual environment 104. In the illustrated scenario, the communications module 140(1) is an integral component of the VEM 114(1) that corresponds to the first participant. In this example, the communications module 140(1) enables the first participant to converse with other participants in the communication session 144 via the input and/or output device 120 (e.g., the participant may hear and speak to other participants through his or her headset and/or see other participant's through a graphical user interface output device).

In some implementations, one or more of the TSMs 116 may include a generic and/or default TSM that is not specifically tailored to any particular participant based on his or her corresponding user-provided toxicity-tolerance data 126. For example, the system 100 may provision a particular participant with a generic TSM based on one or more characteristics such as, for example, the gender of the particular participant, and age of the particular participant, and experience level of the particular participant, or any other characteristic that may be strongly or loosely correlated with tolerance for exposure to one or more socially toxic behaviors.

In some implementations, one or more of the TSMs 116 may be wholly unique to and/or partially customized with respect to a particular participant. For example, the toxicity shield generator 138 may analyze the user data 122 (including but not limited to the profile data 124, the toxicity-tolerance data 126, and/or the settings adjustment data 128 as further described herein) corresponding to the particular participant to generate a customized TSM 116 that correspond specifically to a particular user account. In the illustrated scenario, the virtual environment service 106 deploys the toxicity shield generator 138 to generate a first TSM 116(1) that is unique to a first participant, a second TSM 116(2) that is unique to a second participant, and so on. As further shown in the illustrated scenario, the virtual environment service 106 ultimately transmits the first TSM 116(1) to the client device 102(1) that corresponds to the first participant, the second TSM 116(2) to the client device 102(2) that corresponds to the second participant, and so on.

While participating in the multiuser virtual environment 104, individual participants may cause their respective client device 102 to transmit and/or receive communications data 142 with respect to the communications session 144. In the illustrated scenario, the client device 102(1) is transmitting communications data 142(1) into the communications session 144, the client device 102(2) is transmitting communications data 142(2) into the communication session 144, and so on.

FIG. 1 further illustrates an exemplary dataflow scenario that may occur based on the illustrated instances of behavior (i.e., depicted as word balloons) in which the system 100 may identify and appropriately respond to instances of toxic behavior. As illustrated, the first participant speaks into the communications session 144 the phrase “Got Ya!” (e.g., the first participant may have just successfully defeated the second participant in a first-person shooter gaming title). As further illustrated, the second participant responds by sharply directing an expletive at the first participant. Under these circumstances, the system 100 may identify the second participant's behavior as an instance of toxic behavior of which the first participant is not tolerant. In some implementations, the first participant may have already indicated to the system 100 (e.g., within his or her corresponding toxicity-tolerance data 126(1)) an intolerance towards being sworn at. Thus, one or more of the TSMs 116 may identify the instance of toxic behavior in real time and prevent the first participant from being exposed to this instance of toxic behavior whatsoever. For example, the second TSM 116(2) may identify the instance of toxic behavior and prevent this instance from being transmitted to the first participant. As another example, the first TSM 116(1) may analyze incoming communications data 142(2) to identify the instance of toxic behavior and furthermore to manage the input/output device 120 of the client device 102(1) to prevent this instance from being audibly played to the first participant.

In some implementations, one or more of the TSMs 116 may report the instance of toxic behavior back to the virtual environment service 106 so that it can be logged with respect to the second participant. As illustrated, the TSM 116(2) is shown to transmit a toxicity report 146 to the virtual environment service 106. For example, the TSM 116(2) may be configured to monitor the second participant's behavior to identify instances of toxic behavior and respond to identified instances by reporting them to the virtual environment service 106. In various implementations, the virtual environment service 106 may assign a toxicity ranking to individual participants based on one or more toxicity reports 146 that have been logged in association with their corresponding user profile. The toxicity rankings may be analyzed by the system 100 to determine relative amounts of computing resources (e.g., processing resources) to use for monitoring any particular participant's communications data 142. For example, a particular participant that has a notable history of toxic behavior may have a relatively larger amount of computing resources deployed to monitor his or her communications data 142 as compared to another participant that has little or no history of toxic behavior. It can be appreciated that the foregoing implementation provides tangible computing benefits in terms of reducing and/or efficiently allocating computing and/or processing resources across a pool of participants that are known to exhibit varying degrees of toxicity.

In some implementations, a relative amount of computing resources being used to monitor a particular participant may be dynamically increased based on one or more indicators as described with respect to the escalation data 136. For example, if the particular participant is currently in a “losing-streak” and/or is speaking with a tone and/or inflection indicating that the particular participant is becoming frustrated and/or angry, the system 100 may divert additional computing resources to monitor the particular participant's behavior more closely to prevent other participants from being exposed to any toxic behavior the particular participant may exhibit in the near future. As a more specific but nonlimiting example, consider an implementation in which the system 100 deploys a word recognition engine that is configured to recognize predetermined toxic words and/or phrases and further deploys a tone recognition engine configured to recognize predetermined toxic tones and/or inflections (e.g., an angry and/or whiny tone). In such an implementation, the system 100 may deploy the tone recognition engine to determine when the particular participant is speaking with a tone indicating that he or she is becoming agitated. Then, based on this determination, the system 100 may begin to deploy the word recognition engine to more closely monitor the content of what the particular participant is saying to other participants. In this way, the system 100 is able to conserve resources by deploying resources to monitor only those participants that are currently likely to exhibit toxic behavior.

In some implementations, the TSM 116(2) may prevent an instance of toxic behavior from being transmitted into the communication session 144 whatsoever in response to a determination that at least one participant of the multiuser virtual environment 104 is intolerant of the instance of toxic behavior. Stated alternatively, the system 100 may be configured to reduce the toxicity-level of the communication session 144 for all participants based on any one participant's toxicity-tolerance data 126. In some implementations, the TSMs 116 may work individually and/or in combination to prevent an instance of toxic behavior from being exposed to only those participants whom would find the instance of toxic behavior to be offensive. To illustrate this point, consider a peer to peer implementation in which each individual client device 102 is communicatively connected to each other client device 102 for purposes of transmitting communications data 142 that originates at that individual client device. Under these circumstances, the TSM 116(2) may determine that the second participant's usage of the expletive would be highly offensive to the first participant that is operating the client device 102(1) but that other participants would not find the second participant's usage of the expletive offensive. In this example, the TSM 116(2) may identify and ultimately prevent a portion of the communications data 142(2) that corresponds to the second participant's use of the expletive from being transmitted to the client device 102(1) but would not prevent this portion from being transmitted to other client devices. It can be appreciated that the foregoing implementations provide tangible computing benefits in terms of reducing network bandwidth usage for at least the reason that instances of toxic behavior are prevented from being transmitted by an offending participant's client device over one or more networks.

In some implementations, the system 100 may determine one or more repercussions that can be applied against an offending participant based on instances of toxic behavior that the offending participant exhibits during the multiuser virtual environment 104. For example, in response to the second participant directing the expletive towards the first participant in the illustrated scenario, the system 100 may reprimand the second participant in various ways. Exemplary reprimands include, but are not limited to, pausing an offending participant's ability to participate in the communication session 144 for a defined period of time such as 30 seconds, one minute, ten minutes, the rest of the gaming session, etc. (e.g., selectively muting only the offending participant so that the offending participant can hear but not speak to other participants), suspending an offending participant's ability to participate in the multiuser virtual environment 104 (e.g., responding to toxic behavior by automatically and/or immediately “kicking” an offending participant out of a multiplayer gaming session), modifying aspects of an offending participant's user profile (e.g., reducing an offending participant's status, reputation, accrued points, accrued resources, etc.), and/or any other suitable reprimand that can serve to mitigate the effects of online disinhibition. Stated alternatively, the system 100 may identify instances of toxic behavior and substitute computing repercussions in place of social repercussions that would likely be present if the participants were communicating in a face-to-face setting rather than through the multiuser virtual environment 104.

In the illustrated scenario, the one or more repercussions may be determined at the virtual environment service 106 based on the toxicity report 146 and/or a historical portion of the communications data 142 (also referred to as “historical communications data”). For example, if the toxicity report 146 indicates that the offending participant's behavior is only slightly toxic (e.g., general and/or complimentary use of an expletive) and the offending participant has rarely exhibited past toxic behavior, then the one or more repercussions may be relatively slight (e.g., an audible warning message played through the offending participant's I/O devices 120). As a more specific but nonlimiting example, the system 100 may transmit a consequence instruction 148 that causes the client device 102(2) to audibly recite to the second participant “Please refrain from inappropriate communications. Your language isn't suitable for all players.” In contrast, if the toxicity report 146 indicates that the offending participant's behavior is highly toxic (e.g., use of an expletive to trash talk or insult another participant) and the offending participant has a long history of toxic behavior, then the one or more repercussions may be relatively harsh (e.g., a suspension of gaming and/or communications privileges). As a more specific but nonlimiting example, the system 100 may transmit a consequence instruction 148 that causes the client device 102(2) to audibly recite to the second participant “That type of language is not tolerated within this gaming session. Also, even after two warnings you're still using that language. Your user account is now being suspended for a predetermined period of time during which time you will not be able to initiate and/or join any gaming sessions.”

In some implementations, the virtual environment service 106 includes a machine learning engine 150 to analyze data sources associated with the multiuser virtual environment 104 and/or the communications session 144 to identify “indicators” that have a strong correlation with an instance of a participant's behavior being perceived as socially toxic by one or more other participants. In some implementations, the machine learning engine 150 may identify indicators based on settings adjustment data 128 corresponding to one or more individual participants. For example, the machine learning engine 150 may identify a correlation between a particular type of behavior (e.g., breathing heavily onto a microphone boom, speaking with a high pitched “whiny” tone, cursing, etc.) occurring within one or more communication sessions and other participants responding by adjusting their respective system settings. Based on the indicators identified by the machine learning engine 150, the toxicity-tolerance data 126 corresponding to one or more particular participants may be dynamically and automatically modified by the system 100 without user input being received from the particular participants. As a more specific but nonlimiting example, the machine learning engine 150 may identify a pattern of the first participant selectively muting other participants in response to being verbally insulted by the other participants. As another example, the machine learning engine 150 may identify a defensive retort such as the illustrated response in which the first participant snaps back at the second participant “Don't talk to me that way!” Under these circumstances, the system 100 may determine that the first participant has a low tolerance for being insulted and may respond by adjusting the first participants toxicity tolerance data 126 accordingly.

In some embodiments, the virtual environment service 106 is configured to analyze the user data 122 corresponding to a plurality of different participants to identify groups of participants that have similar user profiles and/or toxicity tolerances. The virtual environment service 106 may then promote interactions between “like-minded” participants (e.g., participants having similar characteristics). For example, the virtual environment service 106 may transmit introductions between two or more participants that are likely well-suited to interact with one another in a multiuser virtual environment 104 without offending each other. As a more specific but nonlimiting example, the virtual environment service 106 may be configured to match participants having little or no tolerance to be exposed to cursing while matching other participants that have a high tolerance for or even prefer to be exposed to cursing. In this way, the virtual environment service 106 attempts to encourage participants to engage other similarly situated participants rather than attempting to reduce toxicity in any particular multiuser virtual environment 104. In some implementations, a single toxicity engine may be deployed to shield a plurality of similarly situated participants from toxic behaviors. For example, in an implementation in which six participants of a multiuser virtual environment have similar toxicity tolerances, the system 100 may generate and deploy a single TSM with respect to all six participants. In this way, the system 100 is able to group of participants in such a way as to efficiently manage the level of computing resources being deployed to manage toxicity levels within any particular multiuser virtual environment.

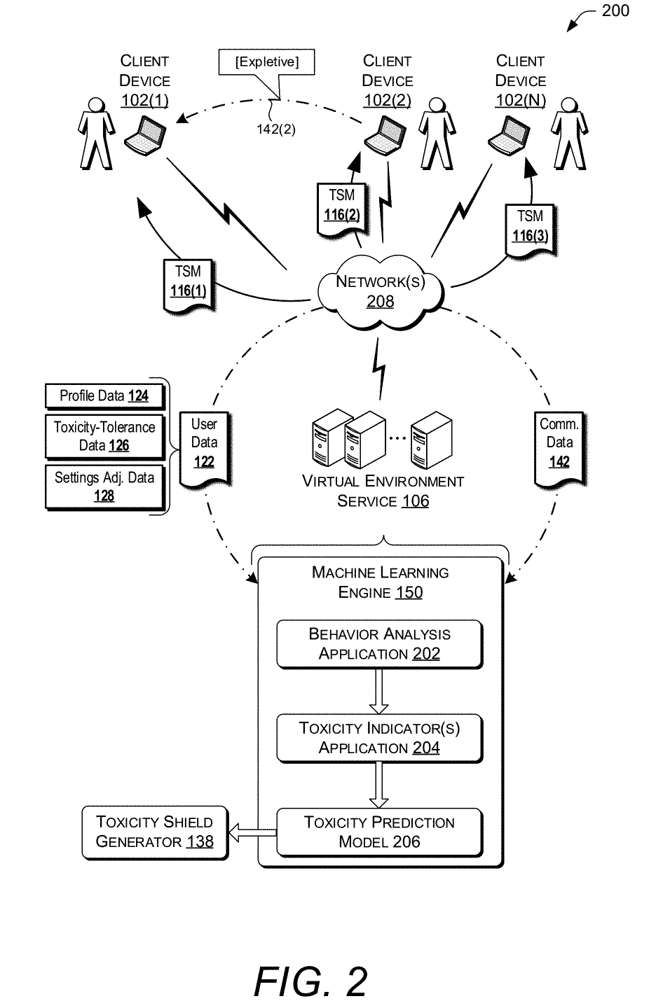

FIG. 2 is a schematic diagram of an illustrative computing environment 200 configured to deploy the machine learning engine 150 to analyze the communications data 142 (either on its own and/or with respect to the user data 122) to generate a toxicity prediction model 206. Ultimately, the toxicity prediction model 206 may be utilized by the toxicity shield generator 138 to refine the one or more TSMs 116 to continually improve user experiences based on observations of the machine learning engine 150.

In some embodiments, the toxicity prediction model 206 may be created by employing supervised learning wherein one or more humans assists in generating labeled training data. For example, a human such as a game developer that authors a title 108, toxicity level officer associated with the virtual environment service 106, a participant of the multiuser virtual environment 104, or any other type of human reviewer may label instances of behavior within historical communications data 142 to be used as training data for the machine learning engine 150 to extract correlations from. The human may further rank the instances of behavior in terms of toxicity. For example, the human may review the historical communications data 142 and label the use of a first expletive as highly toxic but label the use of a second expletive as only slightly toxic (e.g., on a scale of 1 to 100 the user may rank the first expletive toward the top of the scale while ranking the second expletive toward the bottom of the scale). Additionally or alternatively, other machine learning techniques may also be utilized, such as unsupervised learning, semi-supervised learning, classification analysis, regression analysis, clustering, etc. One or more predictive models may also be utilized, such as a group method of data handling, Naïve Bayes, k-nearest neighbor algorithm, majority classifier, support vector machines, random forests, boosted trees, Classification and Regression Trees (CART), neural networks, ordinary least square, and so on.

In the illustrated example, the machine learning engine 150 includes a behavior analysis application 202 for analyzing the communication data 142 to identify various behavioral characteristics of the participants of a multiuser virtual environment 104. As illustrated, the communications data 142 is transmitted to the virtual environment service 106, and ultimately to the machine learning engine 150, over one or more networks 208. Exemplary behavioral characteristics that may be identified by the behavioral analysis application 202 include, but are not limited to:
Cursing: In some instances, participants may invoke offensive words in anger and/or annoyance while conversing with other users within the communications session 144. Accordingly, the behavioral analysis application 202 may identify instances of offensive language being used, e.g. based on the expletive data 132.
Context: In some instances, participants may invoke similar and/or identical words in various contexts. For example, a participant may intentionally insult another participant by directing an expletive at the other participant due to becoming frustrated with and/or angry at the other participant. Alternatively, a participant may use the same expletive in a context that is not intended to insult the other participant (e.g., the participant use the expletive in a complementary context). Accordingly, the behavioral analysis application 202 may distinguish instances of the same word being used in varying contexts to determine whether an instance of the word being used is toxic or not, e.g. based on the contextual data 134.
Frequency: In some instances, participants may exhibit a potentially toxic behavior with varying degrees of frequency. For example, a first participant may invoke offensive language with a relatively higher frequency than a second participant invokes the same offensive language. Under these circumstances, other participants may view each successive instance of the first participant invoking the offensive language as being more toxic than a successive instance of the second participant invoking the same offensive language. Accordingly, the behavioral analysis application 202 may identify a frequency-of-use of toxic behaviors with respect to individual participants.
Non-Verbal: In some instances, a participant may exhibit non-verbal behavioral characteristics that other participants may view as bothersome. For example, a participant may converse with other participants of a communications session 144 while playing loud background music. As another example, a participant may exhibit inadvertent behavior (e.g., “mouth breathing,” sniffling, whistling, dog barking, etc.) near a microphone that is active with respect to the communication session 104. Accordingly, the behavioral analysis application 202 may identify nonverbal behaviors that may potentially be viewed by other participants as bothersome and/or toxic.
   Of course, other types of behavioral characteristics may also be recognized as toxic (or non-toxic for that matter) and are within the scope of the present disclosure.

In the illustrated example, the machine learning engine 150 may include a toxicity indicators application 204 to analyze the user data 122 and/or the communications data 142 to identify “indicators” that the identified behavioral characteristics (e.g., as identified by the behavior analysis application 202) are perceived by other participants as socially toxic and/or non-toxic. The toxicity indicators application 204 deploy an algorithm (e.g., a decision tree, a Naïve Bayes Classification, or any other type of suitable algorithm) to identify various toxicity indicators which include, but are not limited to:
Settings Adjustments: In some instances, a participant may respond to a particular behavioral characteristic by adjusting one or more settings corresponding to the multiuser virtual environment 104 and/or the communication session 144. For example, a participant may respond to being sworn at and/or insulted by another participant by selectively muting the other participant via his or her VEM 114. It can be appreciated that under these circumstances the participant's response may be analogized to ignoring and/or walking away from the other participant to prevent future exposure to being sworn at and/or insulted by the other participant. Accordingly, the toxicity indicators application 204 may determine that a particular type of setting adjustment is indicative of a particular behavioral characteristic as being toxic (or non-toxic for that matter).
Leaving a Virtual Environment: In some instances, a participant may respond to a particular behavioral characteristic by leaving the multiuser virtual environment 104 and/or the communication session 144 altogether. For example, exposure to the particular behavioral characteristic may eliminate a particular user's desire and/or willingness to participate in the multiuser virtual environment 104. In some implementations, the toxicity indicators application 204 may analyze other factors to determine whether the participant leaving the multiuser virtual environment 104 likely resulted from the particular behavioral characteristic or whether the particular behavioral characteristic did not trigger the participant to leave the multiuser virtual environment 104. For example, suppose that a particular participant participates in multiplayer gaming session each evening until roughly the same time. Under these circumstances, the particular participant leaving a multiplayer gaming session at roughly that time again would likely be a poor indication of their tolerance of behavioral characteristics associated with that time.
Reciprocal Behavior vs. Defensive Retorts: In some instances, a participant may reciprocate a particular behavioral characteristic in a jovial manner and/or provide other observable indications that they are not offended by the particular behavioral characteristic. For example, one or more participants may exchange somewhat offensive language while speaking with vocal tones that indicate that they are each happy, joking, or otherwise un-offended. Alternatively, a participant may defensively retort a particular behavioral characteristic in a disagreeable manner and/or provide other observable indications that they are offended by the particular behavioral characteristic. For example, a recipient of hurtful and/or offensive language may sharply respond to an offending participant with a retort for phrase such as “Don't talk to me that way!” Accordingly, the toxicity indicators application 204 may identify various response types that are indicative of a particular behavioral characteristic as being toxic (or non-toxic for that matter).
Relationships: In some instances, one or more participants may have an objectively verifiable relationship that may play a role in how offensive and/or toxic behavioral exhibited between them are perceived. For example, a particular participant may view a behavior with a higher degree of toxicity when coming from a stranger versus the same behavior coming from a family member and/or close friend. Accordingly, the toxicity indicators application 204 may identify variations in how a particular participant response to behavior from other participants that have prior relationships with the particular participant versus other participants that have no such prior relationships with the particular participant.
   Of course, other types of “indicators” may also be recognized within the user data 122 as correlating with any particular identified behavioral characteristic being perceived as toxic (or non-toxic for that matter) and are within the scope of the present disclosure.

Based at least partially on the “indicators” identified by the toxicity indicators application 204, the machine learning engine 150 may build a toxicity prediction model 206 and update and/or revise the toxicity prediction model 206 as data evolves over time. As various indicators may exhibit stronger correlations with a behavioral characteristic being perceived as an instance of socially toxic behavior than other indicators, the machine learning engine 150 may determine weights (e.g., weighting factors) that apportion an influence of each of the indicators with respect to other indicators. As a more specific but nonlimiting example, the machine learning engine 150 may apportion a relatively higher weight to a defensive retort than to leaving a virtual environment.

In some implementations, the machine learning engine 150 may be configured to generate the toxicity prediction model 206 based on a plurality of successive analytical services. The individual analytical services may analyze specific factor-categories with respect to an individual participant. Then, based on the analysis the individual analytical services may assign a score to these specific factor-categories. In a more specific but nonlimiting example, the machine learning engine 150 may deploy an algorithm to successively analyze a first factor-category corresponding to a participant's behavior and/or skill level within a multiuser virtual environment, a second factor-category corresponding to other participants' behavior and/or reputations within other multiuser virtual environments, and a third factor-category corresponding to the participant's user-provided toxicity tolerance data. When analyzing the first factor-category, the machine learning engine 150 may analyze the participant's gaming activities and communications activities to generate a “Behavior/Skill” score for the participant. When analyzing the second factor-category, the machine learning engine 150 may analyze behavior and/or reputation scores of the participant and/or other participants to predict potentially problematic user interactions (e.g., to identify other participants that the participant should not be in a common multiuser virtual environment with). For example, if another participant's reputation score is below a threshold level the machine learning engine 150 may determine that the other participant should be kept away from the participant. When analyzing the third factor-category, the machine learning engine 150 may analyze user-selected toxicity preferences and/or historical settings adjustment data. After having analyzed the various factor-categories, the machine learning engine 150 may perform a cumulative analysis of the various service scores assigned to the various factor-categories to establish a single value indicating how the toxicity shield module participant's customized toxicity shield module is to govern interactions with the user and ultimately, how the customized toxicity shield module will affect the participant's user experience.

Once generated, the toxicity prediction model 206 may be passed to the toxicity shield generator 138 which may use the toxicity prediction model 206 to generate the TSMs 116. In the illustrated example, individual ones of the TSMs 116 are then transmitted from the toxicity shield generator 138 to the client devices 102(1) . . . 102(N) and, ultimately, are deployed to enable particular participants to communicate with other participants while being shielded from one or more predetermined toxic behaviors being exhibited at one or more other participants. For example, one or both of the TSM 116(1) or the TSM 116(2) may analyze the communications data 142(2) to determine that the second participant has exhibited an instance of socially toxic behavior (e.g., the illustrated expletive) toward the first participant. Ultimately, one or both of TSM 116(1) or TSM 116(2) may then take immediate remedial action to prevent the first participant from being exposed to the immediate instance of socially toxic behavior (e.g., immediately mute the second participant with respect to the first participant and/or scrub the immediate expletive from an audio stream played to the first participant) and/or future mitigate of action to prevent the second participant from injecting future socially toxic behavior into the communication session 144 (e.g., temporarily suspend the second participants communications privileges).

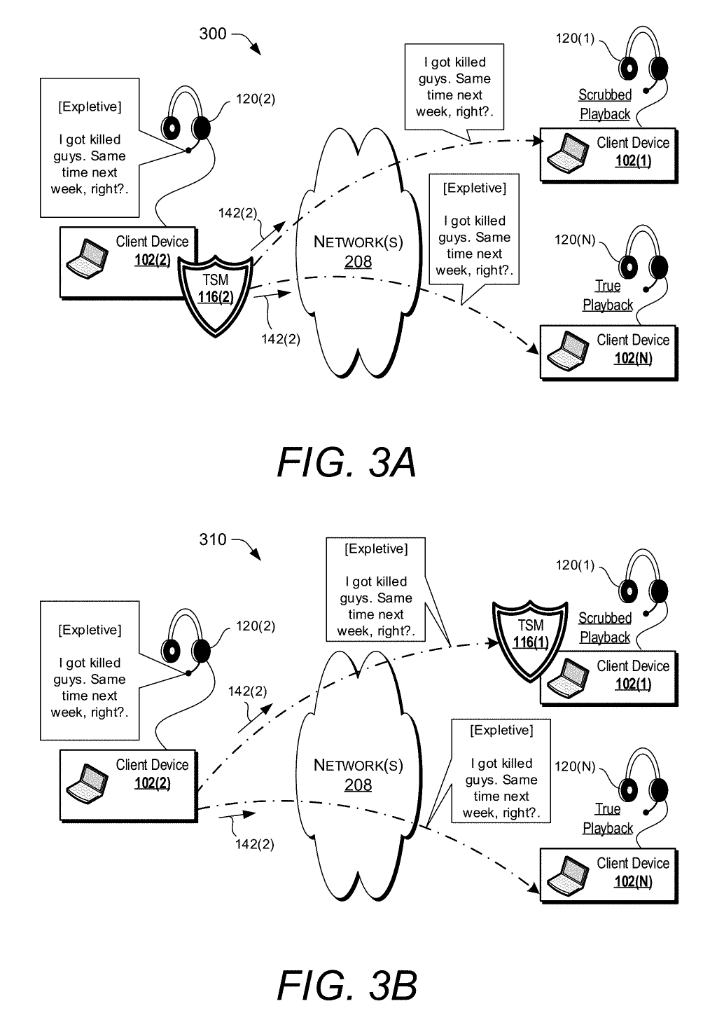

FIG. 3A illustrates an exemplary dataflow scenario 300 in which a TSM 116(2) is operated on a client device 102(2) of an offending participant to prevent transmission of an instance of predetermined toxic behavior to a client device 102(1) of a participant that is intolerant of the predetermined toxic behavior. In the illustrated scenario, the offending participant speaks an expletive into an input/output device 120(2) such as, for example, a gaming headset that includes both earphones to output audio and a microphone and/or camera to receive audio and/or video as input. As the offending participant speaks into the microphone, communications data 142(2) is generated and ultimately transmitted to one or both of the client devices 102(1) and 102(N). However, prior to transmission of the communications data 142(2), the TSM 116(2) analyzes the communications data 142(2) to identify the instance of the predetermined toxic behavior, i.e. the offending participant's use of the expletive. The TSM 116(2) may also analyze toxicity-tolerance data 126 of the participants that are operating the client devices 102(1) and 102(N). Ultimately, the TSM 116(2) determines that the first participant that is operating the client device 102(1) is intolerant of exposure to the expletive whereas the N-th participant that is operating the client device 102(N) is tolerant of exposure to the expletive.

Based on the foregoing determinations, the TSM 116(2) transmits the entirety of the communications data 142(2) to the client device 102(N) so that the N-th participant is exposed to both toxic behavior and the non-toxic behavior of the offending participant. As illustrated, the non-toxic behavior corresponds to the offending participant speaking the phrase “I got killed guys. Same time next week, right?” As further illustrated, the toxic behavior corresponds to the offending participant speaking the expletive. Accordingly, the scrubbed playback that is exposed by (e.g., audibly played) the first input/output device 120(1) includes the non-toxic portion of the communications data 142(2) but does not include the toxic portion. In contrast, the true playback that is exposed by the N-th input/output device 120(N) includes both the non-toxic portion and the toxic portion of the communications data 142(2).

The exemplary dataflow scenario 300 provides benefits over conventional communications techniques for at least the reason that human interaction with the computing devices 102 and/or the multiuser virtual environment 104 is improved by providing individual participants with a unique user experience that is specifically tailored to how tolerant each participant is to various behaviors. Furthermore, the exemplary dataflow scenario 300 reduces bandwidth usage over conventional communications techniques because portions of the communications data 142 that would likely be offensive to individual participants are identified and prevented from being transmitted to client devices associated with those individual participants. For example, suppose that the offending participant is uploading streaming audio from the client device 102(2) at a speed of one-hundred kilobytes per second (kbps) and the TSM 116(2) identifies a ten second portion of the communications data 142(2) that would be offensive to the first participant. Under these circumstances, the exemplary dataflow scenario 300 will reduce bandwidth usage over conventional communications techniques by at least one Megabyte based on this single instance of toxic behavior alone. Considering that by some estimates over six-hundred million people regularly participate in online gaming sessions and furthermore that the toxicity of such online gaming sessions is well documented, it can be appreciated that widespread implementation of the techniques described herein will result in a large-scale reduction in computing resource consumption (namely reduced network bandwidth usage) over conventional communications functionality currently utilized with such online gaming sessions.

FIG. 3B illustrates an exemplary dataflow scenario 310 in which a TSM 116(1) is operated on a client device 102(1) of a participant that is intolerant of a predetermined toxic behavior to prevent a received instance of the predetermined toxic behavior from being exposed via an input output device 120. Exemplary dataflow scenario 310 is similar to exemplary dataflow scenario 300 with the exception that rather than the TSM 116(2) analyzing the communications data 142(2) and determining which portions of the communications data 142(2) to transmit, here the TSM 116(1) receives the full amount of the communications data 142(2) and determines which portions to expose. In particular, rather than the offending participant's client device 102(2) shielding other participants from the offending participant's toxic behavior (as is the case in FIG. 3A), the intolerant participant's client device 102(1) shields the intolerant participant from exposure to toxic portions of the communications data 142(2) that are transmitted over the one or more networks 208.

Although the exemplary dataflow scenarios 300 and 310 each illustrate a TSM 116 being operated by an individual client device 102, in some implementations the TSMs 116 corresponding to individual participants may be operated at the virtual environment service 106. For example, communications data 142 from each individual client device 102 may be first transmitted to the virtual environment service 106 prior to being relayed from the virtual environment service 106 to the other client devices 102 corresponding to any particular communication session 144. In such examples, the virtual environment service 106 may analyze the communications data 142 in real-time to identify instances of toxic behavior and prevent these instances from being exposed by one or more of the client devices 102.

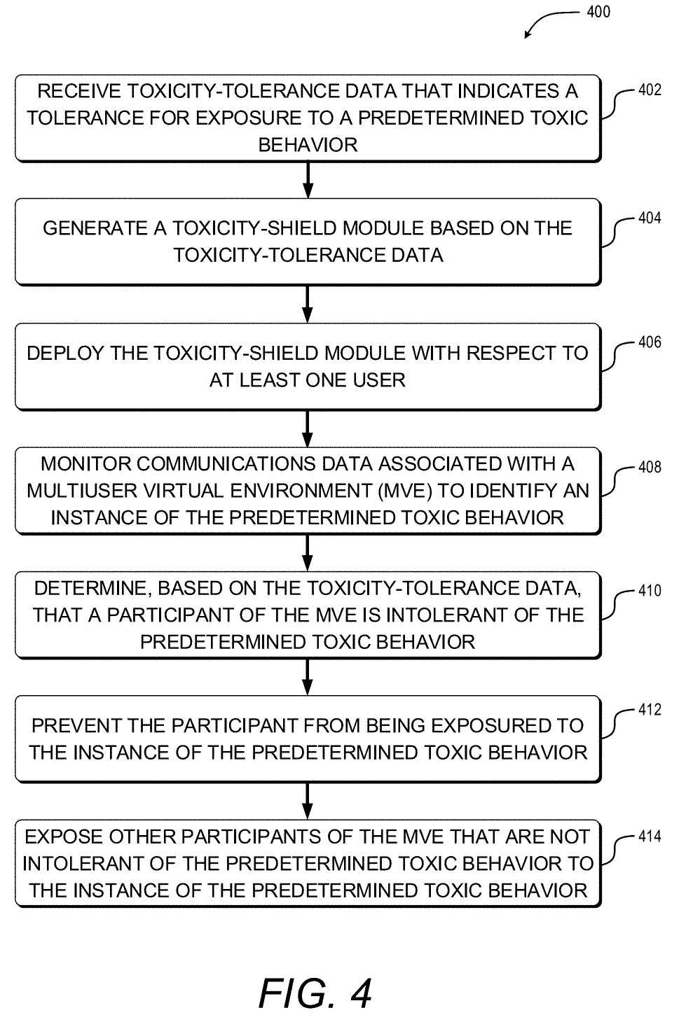

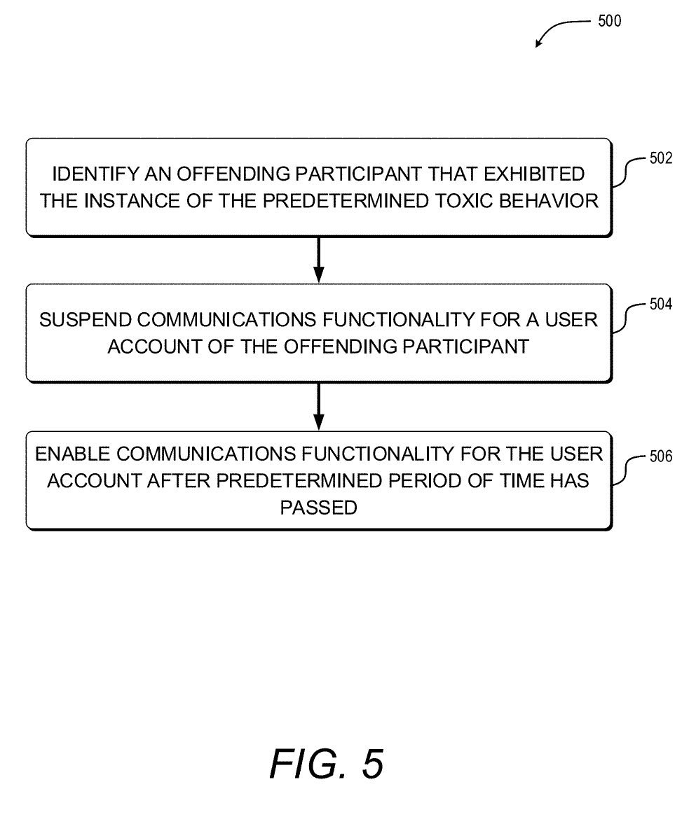

FIGS. 4 and 5 illustrate example flowcharts. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can end at any time and need not be performed in their entirety. Some or all operations of the methods, and/or substantially equivalent operations, can be performed by execution of computer-executable instructions included on a computer-storage media, as defined herein. The term “computer-executable instructions,” and variants thereof, as used in the description and claims, is used expansively herein to include routines, applications, application modules, program modules, programs, components, data structures, algorithms, and the like. Computer-executable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system (e.g., server resources allocated to the virtual environment service 106, and/or client device(s) 102) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

FIG. 4 is a flow diagram of an example method 400 for selectively shielding a participant of a multiuser virtual environment 104 from a predetermined toxic behavior that the participant is intolerant of while exposing the predetermined toxic behavior to other participants of the multiuser virtual environment 104. Exemplary multiuser virtual environments include, but are not limited to, a multiplayer gaming session (e.g., in which remotely located participants can virtually compete with one another while communicating via an in-session voice “chat”) and/or a social networking platform (e.g., in which participants can create public user profiles to communicate with other participants by posting messages, memes, images, videos, etc.).

At block 402, toxicity-tolerance data 126 is received that indicates a tolerance for exposure to a predetermined toxic behavior. In some implementations, the toxicity-tolerance data 126 may correspond to an individual participant and/or a group of participants of the multiuser virtual environment 104. For example, the toxicity-tolerance data 126 may indicate that a first participant of the multiuser virtual environment 104 is highly intolerant of a predetermined list of expletives (e.g., profane and/or vulgar words) whereas another participant of the multiuser virtual environment 104 is indifferent to or even prefers to be exposed to the predetermined list of expletives. In some implementations, the toxicity-tolerance data 126 may indicate a tolerance for a predetermined toxic behavior within the multiuser virtual environment 104 in general. For example, the toxicity-tolerance data 126 may indicate a predetermined rating (e.g., General Audiences—low toxicity suitable for all ages, PG-13—toxicity level unsuitable for children under 13, X—no toxicity restrictions, etc.).

At block 404, a TSM 116 is generated based on the toxicity-tolerance data. For example, the toxicity shield generator 138 may analyze the toxicity-tolerance data 126 to generate a TSM 116 that corresponds to an individual participant. In some implementations, the toxicity shield generator 138 may utilize a toxicity prediction model 206 that is generated by the machine learning engine 150 to generate the TSM 116.

At block 406, the TSM 116 generated at block 404 may be deployed with respect to at least one user within a multiuser virtual environment. In various implementations, deploying the TSM 116 may include one or more of operations described respect to blocks 408 through 414.

At block 408, communications data 142 associated with the multiuser virtual environment 104 is monitored to identify an instance of the predetermined toxic behavior. For example, an instance of an expletive and/or insult may be identified within the communications data 142. In some implementations, the communications data 142 is monitored nearly instantaneously with little or no human perceivable delay to enable the example method 400 to be performed in substantially real-time.

At block 410, it is determined based on the toxicity-tolerance data 126 that a participant of the multiuser virtual environment 104 is intolerant of the predetermined toxic behavior. For example, it may be determined that the participant has previously provided user input to a virtual environment service 106 that indicates that he or she wishes to participate in the multiuser virtual environment 104 without being exposed to the predetermined toxic behavior. As another example, profile data 124 corresponding to the participant may indicate an age of the participant and the predetermined toxic behavior may be pre-designated as unsuitable for the age of the participant. As a more specific but nonlimiting example, the profile data 124 may indicate that the participant is under thirteen years old and the predetermined toxic behavior may be a sexually explicit joke that is not suitable for children under thirteen years of age.

At block 412, the participant is prevented from being exposed to the instance of the predetermined toxic behavior. For example, in the context of the multiplayer gaming session during which remotely located participants communicate via an in-session voice “chat,” preventing the participant from being exposed may include preventing an output device that the participant is using from audibly playing a portion of the communications data that corresponds to the instance of the predetermined toxic behavior. As another example, in the context of the social networking platform, the instance of the predetermined toxic behavior may be an instance of digital content posted on a public user profile of an offending participant. In this example, shielding the participant from exposure may include preventing the instance of digital content from being viewable by the participant even when the participant views the offending participant's public profile. In some implementations, the offending participant may be provided with functionality to selectively expose the instance of digital content to various other participants of the multiuser virtual environment. To illustrate this point, consider that the offending participant may periodically upload content to his or her public user profile and may have some social networking connections for which the uploaded content is suitable (e.g., adults and/or close friends) and may have other social networking connections for which the uploaded content is not suitable (e.g., nieces and/or nephews, coworkers, etc.). According to the techniques described herein, different ones of the offending participant's social networking connections may be provided with access to different versions of the offending participant's public user profile.

At block 414, other participants of the multiuser virtual environment 104 that are not intolerant of the predetermined toxic behavior are exposed to the instance of the predetermined toxic behavior. Thus, individual participants of the multiuser virtual environment 104 may be provided with their own unique user experience while participating in the multiuser virtual environment 104. Furthermore, each participants' unique user experience is specifically tailored to their tolerance for exposure to the predetermined toxic behavior.

FIG. 5 is a flow diagram of an example method for selectively suspending communications functionality of a participant's user account in response to that participant exhibiting a predetermined toxic behavior within a multiuser virtual environment. FIG. 5 (which includes only blocks 502 through 506) can be implemented in association with individual operations and FIG. 4 and/or any other operation described herein whether or not described in relation to a flowchart. For example, operation 502 may be performed in conjunction with and/or immediately after the operation and described with respect to block 410.

At block 502, an identity is determined of an offending participant that exhibited the instance of the predetermined toxic behavior identified at block 408. For example, with reference to the exemplary dataflow scenario of FIG. 1, the system may identify the user account for the second participant that hurled the insulting language toward the first participant. In some implementations, the system is configured to maintain anonymity of the second participant with respect to the first participant.

At block 504, communications functionality is suspended with respect to the user account of the offending participant identified at block 502. In some implementations, suspending communications functionality may include merely preventing the offending participant from further communicating with participants of an immediate multiuser virtual environment. For example, the communications functionality for the offending participant may be resumed upon the offending participant leaving the multiuser virtual environment and joining a different multiuser virtual environment. In some implementations, suspending communications functionality may include placing restrictions on the offending participant's user account to prevent the offending participant from communicating during the current and/or future multiuser virtual environments for at least a predetermined amount of time (e.g., one hour, one day, one week, etc.).

At block 506, communications functionality may be re-enabled for the user account after a predetermined period of time has passed since suspending the communications functionality at block 504. Exemplary predetermined periods of time include, but are not limited to, 30 seconds, one minute, two minutes, five minutes, 10 minutes, 15 minutes, the rest of a communications session (e.g., until a current gaming session is terminated), one day, one week, two weeks, or any other suitable period of time.

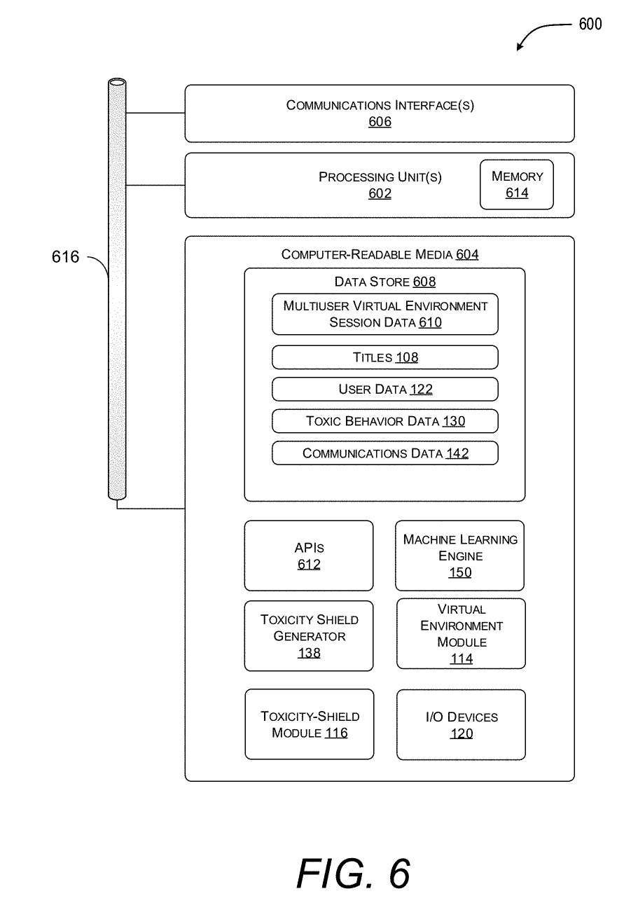

FIG. 6 is a diagram illustrating components of an example device 600 configured to generate and/or deploy a toxicity shield module 116 according to the techniques disclosed herein. The example device 600 can be a client computing device (e.g., 102(1)) and/or a computing resource associated with (e.g., operated by and/or allocated to) the virtual environment service 106. In some instances, the components illustrated in FIG. 6 can be spread across various ones of the devices described herein.

Device 600 includes one or more processing unit(s) 602, computer-readable media 604, communication interface(s) 606. The components of device 600 can be operatively connected, for example, via a bus 616, which can include one or more of a system bus, a data bus, an address bus, a PCI bus, a Mini-PCI bus, and any variety of local, peripheral, and/or independent buses.

As used herein, processing unit(s), such as processing unit(s) 602, processing unit(s) 110, and/or processing unit(s) of other devices used in implementing the techniques described herein, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

As used herein, computer-readable media, such as computer-readable media 604, computer-readable media 112, and/or computer-readable media of other devices, can store instructions executable by the processing unit(s). Computer-readable media can also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media can include computer storage media and/or communication media. Computer storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media can embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 606 can represent, for example, network interface controllers (NICs) or other types of transceiver devices to send and receive communications over a network.

In the illustrated example, computer-readable media 604 can include a data store 608. In some examples, a data store includes data storage such as a database, data warehouse, or other type of structured or unstructured data storage. In some examples, a data store includes a corpus and/or a relational database with one or more tables, indices, stored procedures, and so forth to enable data access including one or more of hypertext markup language (HTML) tables, resource description framework (RDF) tables, web ontology language (OWL) tables, and/or extensible markup language (XML) tables, for example.

Data store 608 can store data for the operations of processes, applications, components, and/or modules stored in computer-readable media 604 and/or executed by processing unit(s) 602 and/or accelerator(s). For instance, in some examples, data store 608 can store multiuser virtual environment session data 610. The multiplayer session data 610 can comprise a total number of participants in the multiuser virtual environment 104, a mode or category of the title 108, activity that occurs in the multiuser virtual environment 104 (e.g., behavior, maneuvers, earned points or a score, and/or achievements of the participants), and/or other data related to when and how the multiuser virtual environment 104 is executed or hosted. In various examples, the data store 608 can also store data associated with the titles 108, user data 122, toxic behavior data 130, and/or communications data 142.

In various examples, before a participant engages in an in-session voice chat experience with other participants of the communication session 144, the participant's privilege and privacy restrictions can be checked to determine banned or blocked participants.

As an alternative, some or all of the above-referenced data can be stored on separate memories 614 on board one or more processing unit(s) 602 such as a memory on board a CPU-type processor, a GPU-type processor, an FPGA-type accelerator, a DSP-type accelerator, and/or another accelerator.

In the illustrated example of FIG. 6, computer-readable media 604 also includes application programming interface(s) (APIs) 612. At least one API is configured to expose the various datatypes and/or modules described herein to, for example, the virtual environment service 106 and/or the client devices 102 (e.g., a desktop computer and/or a gaming console) executing the multiuser virtual environment 104 (e.g., a multiplayer gaming session) and/or program code of the titles 108.

For example, the APIs 612 may be configured to expose the machine learning engine 150 to the toxicity shield generator 138 to enable the toxicity prediction model 206 to be passed from the machine learning engine 150 to the toxicity shield generator 138. The APIs 612 may further be configured to expose the toxicity shield generator 138 to the client devices 102 to enable the toxicity shield generator 1382 pass the generated toxicity shield modules 116 through the networks 208 to the client devices 102. The APIs 612 may further be configured to expose the input output devices 120 to the virtual environment module 114 and/or the toxicity-shield module 116 to enable implementation of the functionality described herein.

The number of illustrated modules is just an example, and the number can vary higher or lower. That is, functionality described herein in association with the illustrated modules can be performed by a fewer number of modules or a larger number of modules on one device or spread across multiple devices.

### EXAMPLE CLAUSES

The disclosure presented herein may be considered in view of the following clauses.

Example Clause A, a system comprising: one or more processing units; and a computer-readable medium having encoded thereon computer-executable instructions to configure the one or more processing units to: receive toxicity-tolerance data from a first client device that corresponds to a first identity of a plurality of identities participating in a multiuser virtual environment, wherein the toxicity-tolerance data indicates at least a tolerance for exposure to a predetermined toxic behavior, and wherein the first client device is communicatively coupled to at least a graphical display output device and an audio output device; monitor communications data associated with the multiuser virtual environment to identify an instance of the predetermined toxic behavior, wherein the instance of the predetermined toxic behavior is generated by a second client device that corresponds to a second identity of the plurality of identities; determine, based on the tolerance, that the first identity is intolerant of the instance of the predetermined toxic behavior; and in response to determining that the first identity is intolerant of the instance of the predetermined toxic behavior, prevent at least one of the graphical display output device or the audio output device from exposing the instance of the predetermined toxic behavior.

Example Clause B, the system of Example Clause A, wherein the toxicity-tolerance data further indicates at least another tolerance, that corresponds to a third identity of the plurality of identities, for exposure to the predetermined toxic behavior, and wherein the computer-executable instructions further configure the one or more processing units to: determine, based on the other tolerance, that the third identity is tolerant of the instance of the predetermined toxic behavior; and in response to determining that the third identity is tolerant of the instance of the predetermined toxic behavior, cause an output device of a third client device, that corresponds to the third identity, to expose the instance of the predetermined toxic behavior.

Example Clause C, the system of any of Example Clauses A through B, wherein the computer-executable instructions further configure the one or more processing units to: receive an indication of one or more setting adjustments corresponding to the at least one of the graphical display output device or the audio output device; analyze the communications data to identify a correlation between the one or more setting adjustments and one or more previous instances of the predetermined toxic behavior; and determine the tolerance based on the correlation between the one or more setting adjustments and the one or more previous instances of the predetermined toxic behavior.

Example Clause D, the system of any of Example Clauses A through C, wherein the computer-executable instructions further configure the one or more processing units to cause an output device of the second client device that corresponds to the second identity, to expose a toxicity-warning that indicates that at least one of the plurality of identities participating in the multiuser virtual environment is intolerant of the predetermined toxic behavior.

Example Clause E, the system of any of Example Clause D, wherein the toxicity-warning retains an anonymity of the first identity with respect to the second identity while indicating that the at least one of the plurality of identities is intolerant of the predetermined toxic behavior.

Example Clause F, the system of any of Example Clauses A through E, wherein the multiuser virtual environment is an at least partially anonymous multiplayer gaming session that is facilitated, at least in part, by a virtual gaming service.

Example Clause G, the system of any of Example Clause F, wherein monitoring the communications data to identify the instance of the predetermined toxic behavior includes monitoring a substantially real-time audio stream of the at least partially anonymous multiplayer gaming session to identify a predetermined expletive.

Example Clause H, the system of any of Example Clauses A through G, wherein the computer-executable instructions further configure the one or more processing units to analyze the communications data to determine a context-of-use of the predetermined toxic behavior with respect to the first identity, wherein determining that the first identity is intolerant of the instance of the predetermined toxic behavior is further based on the context-of-use of the predetermined toxic behavior with respect to the first identity.

While Example Clauses A through H are described above with respect to a system, it is understood in the context of this document that the subject matter of Example Clauses A through H can also be implemented by a device, via a computer-implemented method, and/or via computer-readable storage media.

Example Clause I, a computer-implemented method, comprising: receiving, from a first client device, toxicity-tolerance data that indicates a tolerance for exposure to a predetermined toxic behavior, the tolerance corresponding to a first identity that is associated with a virtual environment service; generating, based on the toxicity-tolerance data, a toxicity-shield module for managing an exposure level of the first identity to the predetermined toxic behavior during a multiuser virtual environment associated with the virtual environment service; and deploying the toxicity-shield module to manage the exposure level of the first identity during the multiuser virtual environment by causing a computing device to: monitor communications data being streamed in association with the multiuser virtual environment to identify an instance of the predetermined toxic behavior, wherein the instance originates from a second client device; and in response to determining that the first identity is at least partially intolerant of the predetermined toxic behavior, prevent an output device of the first client device from exposing at least one of the instance of the predetermined toxic behavior or a portion of the communications data originating from the second client device.

Example Clause J, the computer-implemented method of Example Clause I, wherein the computing device comprises the first client device and deploying the toxicity-shield module includes transmitting the toxicity-shield module to the first client device to enable the first client device to manage the exposure level while contemporaneously facilitating participation of the first identity in the multiuser virtual environment.

Example Clause K, the computer-implemented method of Example Clause J, further comprising receiving, from the first client device, a request associated with at least one of initiating the multiuser virtual environment or joining the multiuser virtual environment, wherein the transmitting the toxicity-shield module to the first client device is at least partially responsive to the receiving the request from the first client device.

Example Clause L, the computer-implemented method of Example Clauses I through K, wherein the computing device comprises the second client device and deploying the toxicity-shield module includes transmitting the toxicity-shield module to the second client device to enable the second client device to manage the exposure level of the first identity to the predetermined toxic behavior while contemporaneously facilitating participation of a second identity in the multiuser virtual environment.

Example Clause M, the computer-implemented method of Example Clauses I through L, wherein the toxicity-shield module is configured deploy a participant-selective mute function associated with the multiuser virtual environment to toggle an individual stream, that corresponds to the second client device, between an audible-state and a muted-state.

Example Clause N, the computer-implemented method of Example Clauses I through M, wherein the toxicity-tolerance data indicates a correlation between one or more previous instances of the predetermined toxic behavior and one or more setting adjustments associated with the output device, and wherein the toxicity-shield module is at least partially customized for the first identity based on the correlation.

Example Clause O, the computer-implemented method of Example Clauses I through N, wherein the toxicity-shield module further causes the computing device to: monitor at least one of the communications data or historical communications data, associated with a previous multiuser virtual environment, to determine at least one of: a context-of-use of the predetermined toxic behavior with respect to the first identity, or a frequency-of-use of the predetermined toxic behavior during at least one of the multiuser virtual environment or the previous multiuser virtual environment; and determine whether the first identity is at least partially intolerant of the predetermined toxic behavior based on at least one of the context-of-use or the frequency-of-use.

Example Clause P, the computer-implemented method of Example Clauses I through O, wherein the generating the toxicity-shield module is further based on a toxicity prediction model that is generated by a machine learning engine based on an analysis of the communications data with respect to settings adjustment data.

While Example Clauses I through P are described above with respect to a method, it is understood in the context of this document that the subject matter of Example Clauses I through P can also be implemented by a device, by a system, and/or via computer-readable storage media.

Example Clause Q, a system comprising: one or more processing units; and a computer-readable medium having encoded thereon computer-executable instructions to configure the one or more processing units to: receive, from a first client device, toxicity-tolerance data corresponding to at least a first identity of a plurality of identities associated with a virtual environment service, wherein the toxicity-tolerance data indicates at least a tolerance for a predetermined toxic behavior within a communication session that is facilitated by the virtual environment service; monitor communications data associated with the communication session to identify an instance of the predetermined toxic behavior that originates from a second client device, wherein the communications data corresponds to a substantially live conversation between the plurality of identifies during the communication session; determine that the first identity is intolerant of the instance of the predetermined toxic behavior based on the instance of the predetermined toxic behavior exceeding the tolerance; and in response to determining that the first identity is intolerant of the instance of the predetermined toxic behavior, suspend a communications functionality of the second client device with respect to the substantially live conversation for a predetermined amount of time.

Example Clause R, the system of Example Clause Q, wherein the predetermined amount of time is defined by a termination of the communication session.

Example Clause S, the system of any of Example Clauses Q through R, wherein the second client device deploys a toxicity-shield module (TSM) during the substantially live conversation to identify the instance of the predetermined toxic behavior and to suspend the communications functionality in response to determining that the first identity is intolerant of the instance of the predetermined toxic behavior.

Example Clause T, the system of any of Example Clauses Q through S, wherein the first client device deploys a toxicity-shield module (TSM) during the substantially live conversation to identify the instance of the predetermined toxic behavior and to prevent an output device, of the first client device, from exposing the instance of the predetermined toxic behavior.

While Example Clauses Q through T are described above with respect to a system, it is understood in the context of this document that the subject matter of Example Clauses Q through T can also be implemented by a device, via a computer-implemented method, and/or via computer-readable storage media.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A system comprising:
one or more processing units; and
a computer-readable medium having encoded thereon computer-executable instructions to configure the one or more processing units to:
receive toxicity-tolerance data from a first client device that corresponds to a first identity of a plurality of identities participating in a multiuser virtual environment, wherein the toxicity-tolerance data indicates at least a tolerance for exposure to a predetermined toxic behavior, and wherein the first client device is communicatively coupled to at least a graphical display output device and an audio output device;
monitor communications data associated with the multiuser virtual environment to identify an instance of the predetermined toxic behavior, wherein the instance of the predetermined toxic behavior is generated by a second client device that corresponds to a second identity of the plurality of identities;
determine, based on the tolerance, that the first identity is intolerant of the instance of the predetermined toxic behavior; and
in response to determining that the first identity is intolerant of the instance of the predetermined toxic behavior, prevent at least one of the graphical display output device or the audio output device from exposing the instance of the predetermined toxic behavior.

2. The system of claim 1, wherein the toxicity-tolerance data further indicates at least another tolerance, that corresponds to a third identity of the plurality of identities, for exposure to the predetermined toxic behavior, and wherein the computer-executable instructions further configure the one or more processing units to:
determine, based on the other tolerance, that the third identity is tolerant of the instance of the predetermined toxic behavior; and
in response to determining that the third identity is tolerant of the instance of the predetermined toxic behavior, cause an output device of a third client device, that corresponds to the third identity, to expose the instance of the predetermined toxic behavior.

3. The system of claim 1, wherein the computer-executable instructions further configure the one or more processing units to:
receive an indication of one or more setting adjustments corresponding to the at least one of the graphical display output device or the audio output device;
analyze the communications data to identify a correlation between the one or more setting adjustments and one or more previous instances of the predetermined toxic behavior; and
determine the tolerance based on the correlation between the one or more setting adjustments and the one or more previous instances of the predetermined toxic behavior.

4. The system of claim 1, wherein the computer-executable instructions further configure the one or more processing units to cause an output device of the second client device that corresponds to the second identity, to expose a toxicity-warning that indicates that at least one of the plurality of identities participating in the multiuser virtual environment is intolerant of the predetermined toxic behavior.

5. The system of claim 4, wherein the toxicity-warning retains an anonymity of the first identity with respect to the second identity while indicating that the at least one of the plurality of identities is intolerant of the predetermined toxic behavior.

6. The system of claim 1, wherein the multiuser virtual environment is an at least partially anonymous multiplayer gaming session that is facilitated, at least in part, by a virtual gaming service.

7. The system of claim 6, wherein monitoring the communications data to identify the instance of the predetermined toxic behavior includes monitoring a substantially real-time audio stream of the at least partially anonymous multiplayer gaming session to identify a predetermined expletive.

8. The system of claim 1, wherein the computer-executable instructions further configure the one or more processing units to analyze the communications data to determine a context-of-use of the predetermined toxic behavior with respect to the first identity, wherein determining that the first identity is intolerant of the instance of the predetermined toxic behavior is further based on the context-of-use of the predetermined toxic behavior with respect to the first identity.

9. A computer-implemented method, comprising:
receiving, from a first client device, toxicity-tolerance data that indicates a tolerance for exposure to a predetermined toxic behavior, the tolerance corresponding to a first identity that is associated with a virtual environment service;
generating, based on the toxicity-tolerance data, a toxicity-shield module for managing an exposure level of the first identity to the predetermined toxic behavior during a multiuser virtual environment associated with the virtual environment service; and
deploying the toxicity-shield module to manage the exposure level of the first identity during the multiuser virtual environment by causing a computing device to:
monitor communications data being streamed in association with the multiuser virtual environment to identify an instance of the predetermined toxic behavior, wherein the instance originates from a second client device; and
in response to determining that the first identity is at least partially intolerant of the predetermined toxic behavior, prevent an output device of the first client device from exposing at least one of the instance of the predetermined toxic behavior or a portion of the communications data originating from the second client device.

10. The computer-implemented method of claim 9, wherein the computing device comprises the first client device and deploying the toxicity-shield module includes transmitting the toxicity-shield module to the first client device to enable the first client device to manage the exposure level while contemporaneously facilitating participation of the first identity in the multiuser virtual environment.

11. The computer-implemented method of claim 10, further comprising receiving, from the first client device, a request associated with at least one of initiating the multiuser virtual environment or joining the multiuser virtual environment, wherein the transmitting the toxicity-shield module to the first client device is at least partially responsive to the receiving the request from the first client device.

12. The computer-implemented method of claim 9, wherein the computing device comprises the second client device and deploying the toxicity-shield module includes transmitting the toxicity-shield module to the second client device to enable the second client device to manage the exposure level of the first identity to the predetermined toxic behavior while contemporaneously facilitating participation of a second identity in the multiuser virtual environment.

13. The computer-implemented method of claim 9, wherein the toxicity-shield module is configured deploy a participant-selective mute function associated with the multiuser virtual environment to toggle an individual stream, that corresponds to the second client device, between an audible-state and a muted-state.

14. The computer-implemented method of claim 9, wherein the toxicity-tolerance data indicates a correlation between one or more previous instances of the predetermined toxic behavior and one or more setting adjustments associated with the output device, and wherein the toxicity-shield module is at least partially customized for the first identity based on the correlation.

15. The computer-implemented method of claim 9, wherein the toxicity-shield module further causes the computing device to:
monitor at least one of the communications data or historical communications data, associated with a previous multiuser virtual environment, to determine at least one of: a context-of-use of the predetermined toxic behavior with respect to the first identity, or a frequency-of-use of the predetermined toxic behavior during at least one of the multiuser virtual environment or the previous multiuser virtual environment; and
determine whether the first identity is at least partially intolerant of the predetermined toxic behavior based on at least one of the context-of-use or the frequency-of-use.

16. The computer-implemented method of claim 9, wherein the generating the toxicity-shield module is further based on a toxicity prediction model that is generated by a machine learning engine based on an analysis of the communications data with respect to settings adjustment data.

17. A system comprising:
one or more processing units; and
a computer-readable medium having encoded thereon computer-executable instructions to configure the one or more processing units to:
receive, from a first client device, toxicity-tolerance data corresponding to at least a first identity of a plurality of identities associated with a virtual environment service, wherein the toxicity-tolerance data indicates at least a tolerance for a predetermined toxic behavior within a communication session that is facilitated by the virtual environment service;
monitor communications data associated with the communication session to identify an instance of the predetermined toxic behavior that originates from a second client device, wherein the communications data corresponds to a substantially live conversation between the plurality of identifies during the communication session;
determine that the first identity is intolerant of the instance of the predetermined toxic behavior based on the instance of the predetermined toxic behavior exceeding the tolerance; and
in response to determining that the first identity is intolerant of the instance of the predetermined toxic behavior, suspend a communications functionality of the second client device with respect to the substantially live conversation for a predetermined amount of time.

18. The system of claim 17, wherein the predetermined amount of time is defined by a termination of the communication session.

19. The system of claim 17, wherein the second client device deploys a toxicity-shield module (TSM) during the substantially live conversation to identify the instance of the predetermined toxic behavior and to suspend the communications functionality in response to determining that the first identity is intolerant of the instance of the predetermined toxic behavior.

20. The system of claim 17, wherein the first client device deploys a toxicity-shield module (TSM) during the substantially live conversation to identify the instance of the predetermined toxic behavior and to prevent an output device, of the first client device, from exposing the instance of the predetermined toxic behavior.
